(19) United States
(12) Patent Application Publication
(10) Pub. No.: US 2024/0420441 A1
(43) Pub. Date: Dec. 19, 2024

(54) Occupancy Sensing Device and Occupancy Sensing Method

(71) Applicant: Himax Imaging Limited, Tainan City (TW)

(72) Inventors: Wei-Chieh Yang, Tainan City (TW); Po-Chang Chen, Tainan City (TW)

(73) Assignee: Himax Imaging Limited, Tainan City (TW)

(21) Appl. No.: 18/211,295

(22) Filed: Jun. 19, 2023

(51) Int. Cl. G06V 10/25; G06T 7/20

(52) U.S. Cl. CPC G06V 10/25; G06T 7/20; G06T 2207/20084; G06V 2201/07

(57) ABSTRACT

An occupancy sensing device comprises an ROI readout unit, configured to excerpt an ROI image from a plurality of consecutive images in response to an ROI request; an object tracking unit, coupled to the ROI readout unit, configured to perform object tracking to obtain a moving object list according to motion data of the plurality of consecutive images, determine to send the ROI request according to a first policy, and determine an object tracking result according to the moving object list and an object recognition result; an object recognition unit, coupled to the ROI readout unit, configured to perform object recognition to obtain the object recognition result according to the ROI image; and an occupancy determination unit, coupled to the object tracking unit, configured to determine an occupancy status according to the object tracking result; wherein the first policy comprises an appearance and a disappearance of an object.

### BACKGROUND OF THE INVENTION

### 1. Field of the Invention

The present invention is related to an electronic device and a detection method for occupancy sensing, and more particularly, to an electronic device and a detection method for occupancy sensing with low energy consumption.

### 2. Description of the Prior Art

An occupancy sensor is an electronic device for detecting the presence of a person and used to control lights, temperature, ventilation systems, etc. accordingly, so as to save energy and achieve an automatic control. For example, a typical application of the occupancy sensor is automatically turning on or off the lights when detecting that someone enters or leaves a certain space.

Conventionally, the occupancy sensor uses motion sensors such as passive infrared sensor (PIR) or ultrasound sensor to detect the presence of a person, namely an occupant. However, these sensors may trigger falsely and are not good at monitoring occupants who are still or do not move much. For example, if no motion is detected by the sensors, the space is considered empty and thus no lighting is required, which is annoying for occupants without significant movement.

In order to improve the above problem, an image sensor is adopted to perform occupancy sensing. The image sensor can detect changes in pixels between two consecutive frames and decide if there is an occupant in the space and control other devices (such as light). Image analysis techniques such as shape detection or human detection for image sensors are also used to identify occupants who are still or do not move much, which makes occupancy sensing more sensitive and accurate. However, due to the large amount of data and computation involved, occupancy sensing using image sensors typically has drawbacks such as high power consumption and cost. In practice, to simplify setup, the occupancy sensor may be battery powered, but this means shorter operation lifetime and more maintenance effort.

With the increasing focus on cost and energy, how to design an occupancy sensor with high accuracy, robustness, energy saving and economy has become an important issue in the art.

### SUMMARY OF THE INVENTION

Therefore, the present invention is to provide an occupancy sensing device and an occupancy sensing method with image-based sensor, which avoids the miss detection for sedentary or stationary occupant and minimizes the power consumption without sacrificing the performance.

An embodiment of the present invention discloses an occupancy sensing device, and the occupancy sensing device comprises a region-of-interest (ROI) readout unit, an object tracking unit, an object recognition unit and an occupancy determination unit. The ROI readout unit is configured to excerpt an ROI image from a plurality of consecutive images of a space in response to an ROI request. The object tracking unit is coupled to the ROI readout unit and configured to perform object tracking to obtain a moving object list according to motion data of the plurality of consecutive images, determine to send the ROI request according to a first policy, and determine an object tracking result according to the moving object list and an object recognition result. The object recognition unit is coupled to the ROI readout unit and configured to perform object recognition to obtain the object recognition result according to the ROI image. The occupancy determination unit is coupled to the object tracking unit and configured to determine an occupancy status of the space according to the object tracking result. The first policy comprises that the ROI request is sent except that a moving object in the moving object list and a tracking object in a tracking list are corresponding matched. The object tracking result comprises the tracking list.

An embodiment of the present invention further discloses an occupancy sensing method, and the occupancy sensing method comprises excerpting an ROI image from a plurality of consecutive images of a space in response to an ROI request; performing object tracking to obtain a moving object list according to motion data of the plurality of consecutive images, determining to send the ROI request according to a first policy, and determine an object tracking result according to the moving object list and an object recognition result; performing object recognition to obtain the object recognition result according to the ROI image; and determining an occupancy status of the space according to the object tracking result. The first policy comprises that the ROI request is sent except that a moving object in the moving object list and a tracking object in a tracking list are corresponding matched. The object tracking result comprises the tracking list.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an occupancy sensing device according to a conventional method.

FIG. 2 is a schematic diagram of an occupancy sensing device according to an embodiment of the present invention.

FIG. 3 is a schematic diagram of a process for an occupancy sensing method according to an embodiment of the present invention.

FIG. 4 is a schematic diagram of a process for an object tracking method according to an embodiment of the present invention.

FIG. 5 is a schematic diagram of an example of the object tracking method according to an embodiment of the present invention.

FIG. 6 is a schematic diagram of an occupancy sensing device according to an embodiment of the present invention.

### DETAILED DESCRIPTION

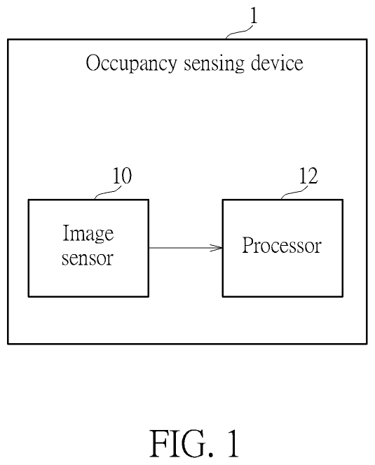

Please refer to FIG. 1, which is a schematic diagram of an occupancy sensing device 1. The occupancy sensing device 1 comprises an image sensor 10 and a processor 12, and the image sensor 10 is coupled to the processor 12. The image sensor 10 captures a plurality of consecutive images of a specific space and transfers the plurality of consecutive images to the processor 12 for further processing. The processor 12 performs image analysis based on the plurality of consecutive images captured by the image sensor 10 to determine an occupancy status of the space. In this way, the image sensor 10 needs to transfer a huge amount of image data to the processor 12, resulting in a large amount of energy consumption. On the other hand, the processor 12 needs to process the huge amount of image data so as to perform image analysis to determine the occupancy status of the space. The image analysis may include motion detection, shape detection, people detection, object detection and so on, which requires a large number of calculations. Therefore, how to improve the occupancy sensing device 1 is crucial in the art.

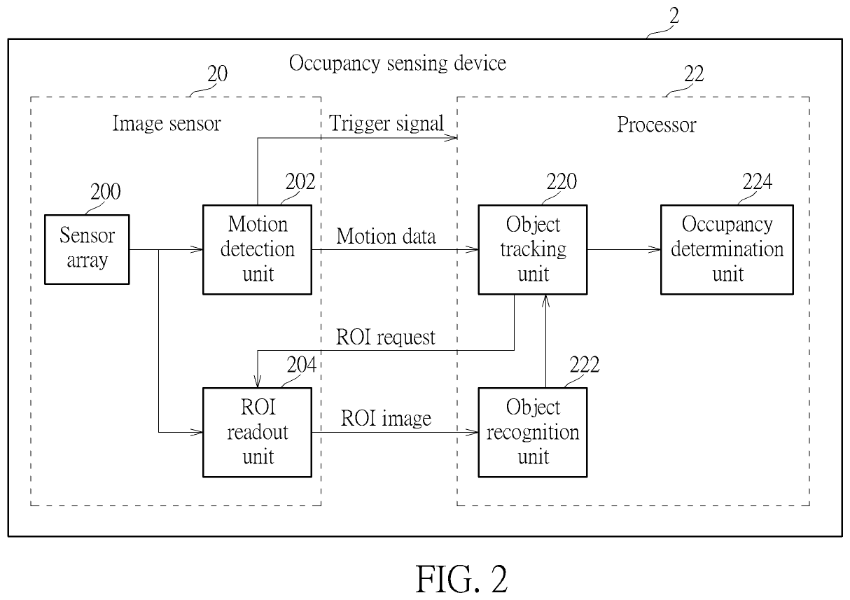

Please refer to FIG. 2, which is a schematic diagram of an occupancy sensing device 2 according to an embodiment of the present embodiment. The occupancy sensing device 2 comprises an image sensor 20 and a processor 22, and the image sensor 20 is coupled to the processor 22. The image sensor 20 is mainly configured for capturing images, while the processor 22 is mainly configured for processing data, which are similar to those of the occupancy sensing device 1. However, the occupancy sensing device 2 shows a way to reduce the amount of data to be transferred between the image sensor 20 and the processor 22, and reduce the amount of data to be processed.

Specifically, the image sensor 20 comprises a sensor array 200, a motion detection unit 202 and a region-of-interest (ROI) readout unit 204. The processor 22 comprises an object tracking unit 220, an object recognition unit 222 and an occupancy determination unit 224.

The sensor array 200 is coupled to the motion detection unit 202 and the ROI readout unit 204, and is configured to capture a plurality of consecutive images of a specific space for subsequent processing. The occupancy sensing device 2 may determine the occupancy status of the space through analyzing the plurality consecutive images captured by the sensor array 200.

The motion detection unit 202 is coupled to the sensor array 200 and the object tracking unit 220, and is configured to perform motion detection algorithm on the plurality of consecutive images captured by the sensor array 200. The motion detection algorithm may consider time difference and background subtraction, etc., and is not limited thereto. Typically, the motion detection unit 202 may output a motion data that is obtained by calculating the temporal difference between two consecutive images. The motion data may be and not limited to a motion map of a binary image representing positions with motion detected, or a list of bounding boxes that indicates the rectangle area with motion detected and moving objects. The motion data may be transferred from the image sensor 20 to the processor 22 for subsequent analysis. It should be noted that, compared to the occupancy sensing device 1, the image sensor 20 does not transfer the plurality of consecutive image to the processor 22, which saves bandwidth and greatly reduces power consumption. Moreover, the motion detection unit 202 may send a trigger signal to the processor 22, and the processor 22 may switch from a standby mode to a detect mode and start receiving motion data in response to receiving the trigger signal.

The ROI readout unit 204 is coupled to the sensor array 200, the object tracking unit 220 and the object recognition unit 222, and is configured to output merely some portions of the plurality of consecutive images. In response to receiving an ROI request, the ROI readout unit 204 may excerpt an ROI image from the plurality of consecutive images according to the region information such as coordination or size carried in the ROI request. Then, the ROI images may be transferred to the processor 22 for subsequent analysis. It should be noted that, in the embodiment, rather than transferring the plurality of consecutive images captured by the sensor array 200 to the processor 22, only the motion data mentioned above and the ROI images being requested may be transferred to the processor 22, which greatly reduces the amount of data that needs to be analyzed through the processor 22.

The object recognition unit 222 is coupled to the ROI readout unit 204 and the object tracking unit 220, and is configured to check whether an ROI image contains objects of interest such as human beings. The object recognition unit 222 may receive an ROI image from the ROI readout unit 204, and then perform object recognition to check the contents of the ROI image so as to obtain an object recognition result relative to the ROI image. The embodiment of the present invention adopts a neural network-based algorithm such as convolutional neural networks (CNN) to implement the object recognition to obtain the object recognition result, but is not limited thereto. The object recognition result may indicate whether the ROI image contains objects of interest, which helps to provide additional information for the detected moving object to improve the accuracy of occupancy sensing. It should be noted that, rather than performing object recognition to all of the plurality of consecutive images, the present invention may only perform object recognition to the ROI images requested, which further reduces the computations.

The object tracking unit 220 is coupled to the motion detection unit 202, the ROI readout unit 204 and the object recognition unit 222, and is configured to track the objects of interest and output an object tracking result. The object tracking unit 220 may perform an object tracking method so as to maintain a tracking list according to the motion data received from the motion detection unit 202 and the object recognition results received from the object recognition unit 222. The tracking list comprises a plurality of tracking objects with the form of bounding box, and the bounding box indicates a region with object of interest. Adding an object into the tracking list means starting to track the object and a tracker is initialized thereto; removing an object from the tracking list means stopping tracking and the tracker is released. The object tracking result may indicate the number of the tracking objects in the tracking list for further processing.

The occupancy determination unit 224 is coupled to the object tracking unit 220, and is configured to determine an occupancy status of the space. According to the object tracking result obtained from the object tracking unit 220, the occupancy determination unit 224 may obtain information about the number of tracking objects, i.e., existing occupants. If the number of tracking objects is not zero, the occupancy determination unit 224 may determine that the space is occupied and the occupancy status is an occupancy state; otherwise, the occupancy status is a non-occupancy state.

In short, the occupancy sensing device 2 shows a way to reduce the amount of data to be transferred between the image sensor 20 and the processor 22, and reduce the amount of data to be processed. Accordingly, the power consumption issue in the occupancy sensing device with image sensors may be improved.

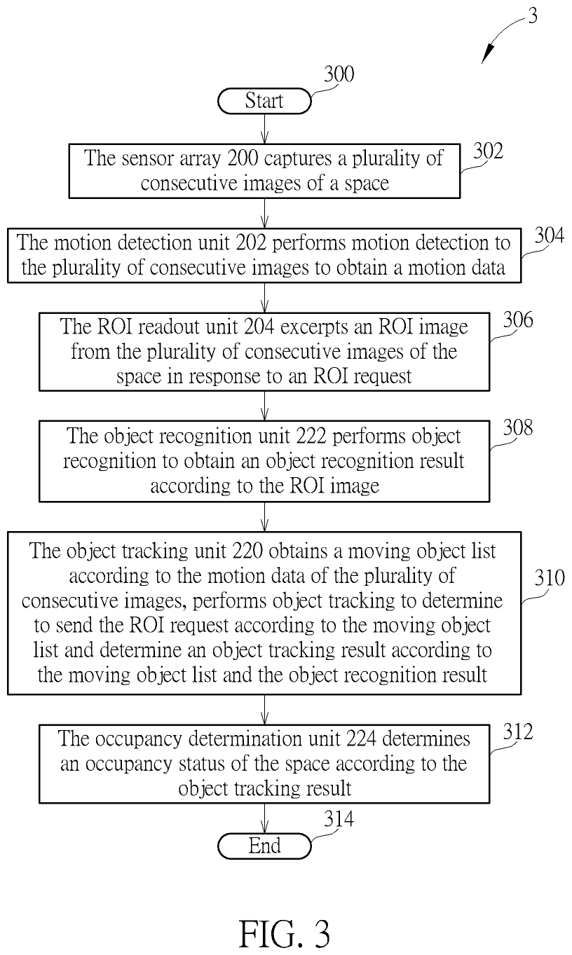

The above occupancy sensing method executed by the occupancy sensing device 2 may be summarized into a process 3 as shown in FIG. 3. The process 3 comprises the following steps:

Step 300: Start.

Step 302: The sensor array 200 captures a plurality of consecutive images of a space.

Step 304: The motion detection unit 202 performs motion detection to the plurality of consecutive images to obtain a motion data.

Step 306: The ROI readout unit 204 excerpts an ROI image from the plurality of consecutive images of the space in response to an ROI request.

Step 308: The object recognition unit 222 performs object recognition to obtain an object recognition result according to the ROI image.

Step 310: The object tracking unit 220 obtains a moving object list according to the motion data of the plurality of consecutive images, performs object tracking to determine to send the ROI request according to the moving object list and determine an object tracking result according to the moving object list and the object recognition result.

Step 312: The occupancy determination unit 224 determines an occupancy status of the space according to the object tracking result.

### Step 314: End.

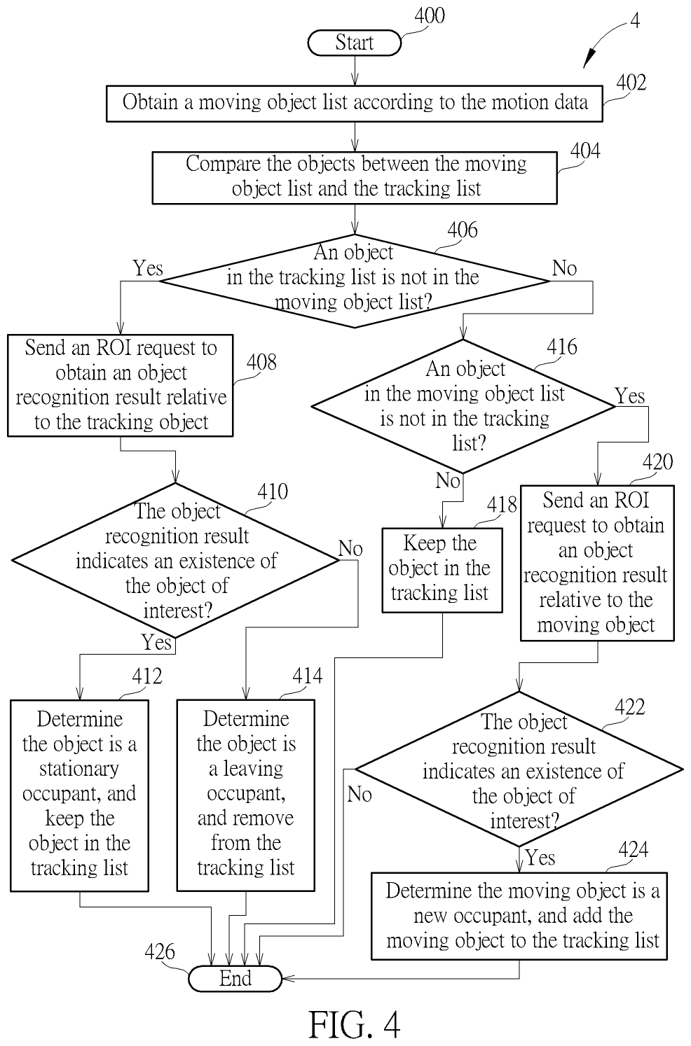

The object tracking method executed by the object tracking unit 220 in Step 310 may be summarized into a process 4 as shown in FIG. 4. The process 4 comprises the following steps:

Step 400: Start.

Step 402: Obtain a moving object list according to the motion data.

Step 404: Compare the objects between the moving object list and the tracking list.

Step 406: Determine whether an object in the tracking list is not in the moving object list. If yes, go to Step 408; otherwise, go to Step 416.

Step 408: Send an ROI request to obtain an object recognition result relative to the tracking object, and proceed to Step 410.

Step 410: Determine whether the object recognition result indicates an existence of the object of interest. If yes, go to Step 412; otherwise, go to Step 414.

Step 412: Determine the object is a stationary occupant, and keep the object in the tracking list.

Step 414: Determine the object is a leaving occupant, and remove from the tracking list.

Step 416: Determine whether an object in the moving object list is not in the tracking list. If yes, go to Step 420; otherwise, go to Step 418.

Step 418: Keep the object in the tracking list.

Step 420: Send an ROI request to obtain an object recognition result relative to the moving object, and proceed to Step 422.

Step 422: Determine whether the object recognition result indicates an existence of the object of interest. If yes, go to Step 424; otherwise, go to Step 426.

Step 424: Determine the moving object is a new occupant, and add the moving object to the tracking list.

Step 426: End.

According to the process 4, the object tracking unit 220 first obtains a moving object list according to the motion data received from the motion detection unit 202 in Step 402. The moving object list comprises a plurality of moving objects with the form of bounding box, and the bounding box is obtained by enclosing a region with sufficient changes in pixels between two successive images. The moving objects in the moving object list may be objects of interest that need further check.

In Step 404, the object tracking unit 220 compares the moving objects of the moving object list and the tracking objects of the tracking list so as to identify whether there is the same object. Specifically, the object tracking unit 220 may determine whether objects corresponding to two bounding boxes are the same according to the condition that the overlapping area of the bounding boxes is greater than a first threshold or the distance between the center points of the bounding boxes is less than a second threshold. In other words, if the overlapping area of a bounding box corresponding to a moving object and a bounding box corresponding to a tracking object is large enough or the distance of the center points therebetween is close enough, the moving object and the tracking object may be identified as the same object. Accordingly, the object tracking unit 220 may obtain information about each of the objects in the tracking list, in the moving object list or in both of the tracking list and moving object list at the same time. The information indicates whether a moving object corresponds to an existed tracking object (occupant) or a new untracked object.

According to the information obtained in Step 404, the object tracking unit 220 is able to determine whether an object in the tracking list is not in the moving object list (Step 406). If there is an object that is only in the tracking list but not in the moving object list, it means that a tracked object is no longer moving or has left. The object tracking unit 220 cannot distinguish the above two situations just by the motion data alone, and thus further analysis is required.

In Step 408, the object tracking unit 220 may send an ROI request to the ROI readout unit 204 and receive an object recognition result responsively. In detail, the ROI request comprises region information about the bounding box corresponding to the object that needs further check. After receiving the ROI request, the ROI readout unit may excerpt an ROI image from the plurality of consecutive images according to the region information contained in the ROI request and transfer the excerpted ROI image to the object recognition unit 222. Then, the object recognition unit 222 may perform object recognition to determine the object recognition result and transfer to the object tracking unit 220 for further check. In Step 410, the object recognition result may indicate whether the ROI image relative to the object contains objects of interest. If yes, the object tracking unit 220 determines that there is at least one occupant who is still or does not move much, and should keep the object in the tracking list (i.e., keep tracking) (Step 412); otherwise, the object tracking unit 220 determines that the occupant has left and should remove the object from the tracking list (i.e., no more tracking) (Step 414).

In Step 416, the object tracking unit 220 may further determine whether an object in the moving object list is not in the tracking list. If there is an object that is only in the moving object list but not in the tracking list, it means that the object may be a new occupant who is just entering the space and further check is required.

In Step 420, similar to Step 408, the object tracking unit 220 may send an ROI request to the ROI readout unit 204 and receive an object recognition result responsively. In Step 422, the received object recognition result may indicate whether the ROI image relative to the object contains objects of interest. If yes, the object tracking unit 220 determines that there is at least one new occupant who enters the space, and should add the object to the tracking list (i.e., start tracking) (Step 424); otherwise, the object tracking unit 220 determines that the object is not corresponding to an occupant, which may be a moving object such as robotic vacuum cleaner activities, curtains fluttering, objects falling, etc.

In Step 418, the object is in both of the moving object list and the tracking list at the same time, which means that the object is the occupant who has already been tracked and still keep moving. In this case, the object should be kept in the tracking list, and the object tracking unit 220 keeps monitoring the object.

Accordingly, through the process 4, the object tracking unit 220 tracks not only moving object that may be an object of interest such as human being but also stationary object that may be an occupant who is still and does not move much. It should be noted that, only when the object being tracked does not move or an untracked moving object appears, the object tracking unit 220 sends the ROI request to obtain the object recognition result for further analysis. In other words, only when the object being tracked does not move or an untracked moving object appears, the image sensor 20 transfers the ROI image to the processor 22. Therefore, for the occupancy sensing device 2, only the motion data and the ROI images requested will be transferred from image sensor 20 to the processor 22, which greatly reduces the data to be transferred and computations needed.

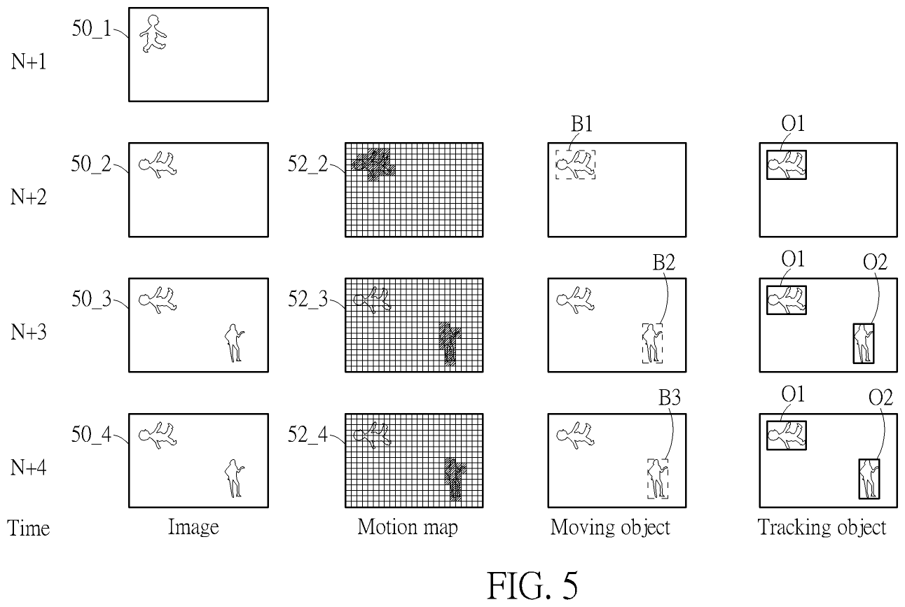

Please refer to FIG. 5, which is a schematic diagram of an example of the object tracking method according to an embodiment of the present invention. In FIG. 5, the sensor array 200 captures images 50_1-50_4 of a space in consecutive time points N+1, N+2, N+3 and N+4. According to the images 50_1-50_4, the motion detection unit 202 obtains motion maps 52_2-52_4, and then bounding boxes B1-B3 with motion are obtained accordingly. The bounding boxes B1-B3 comprises the corresponding moving objects and the occupants O1-O2 are the tracking objects.

In time point N+2, the object tracking unit 220 detects that the bounding box B1 appears and then sends an ROI request to the ROI readout unit 204 to check the content of the bounding box B1, because the bounding box B1 is in the moving object list but not in the tracking list. In this condition, it means that the bounding box B1 may comprise a new occupant. Then, the object tracking unit 220 receives an object recognition result from the object recognition unit 222 that indicates an existence of human being and determines that there is an occupant O1 in the region corresponding to the bounding box B1. Thus, the object tracking unit 220 adds the bounding box B1 to the tracking list as the occupant O1 accordingly.

In time point N+3, the object tracking unit 220 detects that the bounding box B1 with motion corresponding to the occupant O1 of the tracking list disappears and then sends an ROI request to the ROI readout unit 204 to excerpt and then check the content of the bounding box B1 by the object recognition unit 222, because the occupant corresponding to the bound box B1 may be still or does not move much. Then, the object tracking unit 220 receives an object recognition result from the object recognition unit 222 that indicates an existence of human being and determines to keep the occupant O1 in the tracking list accordingly. Moreover, at the same time (i.e., time point N+3), the object tracking unit 220 also detects that the bounding box B2 appears and then sends an ROI request to the ROI readout unit 204 to check the content of the bounding box B2, because the bounding box B2 is in the moving object list but not in the tracking list. Then, the object tracking unit 220 receives an object recognition result from the object recognition unit 222 that indicates an existence of human being and determines that there is an occupant O2 in the region corresponding to the bounding box B2. Thus, the object tracking unit 220 adds the bounding box B2 to the tracking list as an occupant O2 accordingly.

In time point N+4, the object tracking unit 220 detects that the bounding box B3 appears near the occupant O2 and compares the bounding box B3 with the occupant O2 in the tracking list. Then, the object tracking unit 220 determines that the bounding box B3 corresponds to the occupant O2 because the distance of the center points between the bounding box B3 and the bounding box of the occupant O2 (i.e., the bounding box B2) is small enough. Thus, the object tracking unit 220 updates the information of the occupant O2 of the tracking list and keeps tracking the occupant O2 without sending any ROI request. At the same time, since the occupant O1 keeps still or does not move much and the occupant O1 has already been checked in time point N+3, the object tracking unit 220 may not need to send ROI request again to check if the tracking object (occupant O1) is object of interest. Thus, the object tracking unit 220 may skip sending ROI request and just keep tracking the occupant O1. In a brief, the ROI request is sent except that a moving object in the moving object list and a tracking object in the tracking list are corresponding matched.

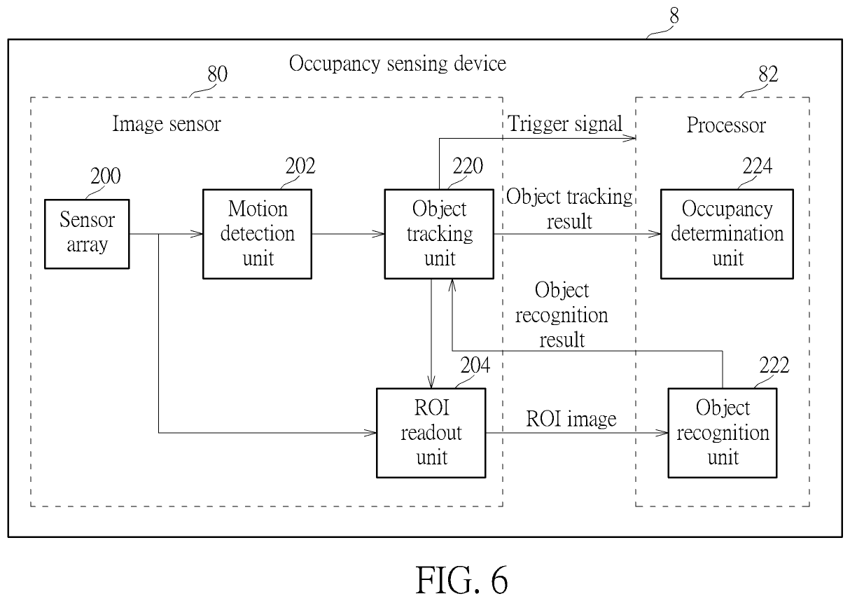

Please refer to FIG. 6, which is a schematic diagram of an occupancy sensing device 8 according to an embodiment of the present invention. The occupancy sensing device 8 has almost the same architecture with the occupancy sensing device 2 mentioned above except for the object tracking unit 220. Specifically, the occupancy sensing device 8 comprises an image sensor 80 and a processor 82, and the image sensor 80 is coupled to the processor 82. Compared to the occupancy sensing device 2, due to the change to implementation of the object tracking unit 220, only an object tracking result (e.g., a number of the tracking objects) and ROI images requested by ROI requests may be transferred from the image sensor 80 to the processor 82. Compared with the occupancy sensing device 2 which requires to trigger the processor and send the motion data per captured image, the occupancy sensing device 8 can only trigger the processor when there is a ROI request or the object tracking result changes (e.g., the number of the tracking objects changes). Thus, the image sensor 80 further reduces the data to be transferred and the processor 82 may operate in a standby mode for a longer period of time, resulting in further lower power consumption for the occupancy sensing device 8.

In detail, the image sensor 80 comprises the sensor array 200, the motion detection unit 202, the object tracking unit 220 and the ROI readout unit 204. The processor 82 comprises the object recognition unit 222 and the occupancy determination unit 224. All of the sensor array 200, the motion detection unit 202, the object tracking unit 220, the ROI readout unit 204, the object tracking unit 220, the object recognition unit 222 and the occupancy determination unit 224 operate in the same way as in the occupancy sensing device 2. However, the different configuration about the object tracking unit 220 results in a more energy-efficient occupancy sensing device.

In summary, the present invention provides an occupancy sensing method and an occupancy sensing device that reduce the amount of the data to be transferred between an image sensor and a processor, and thus the disadvantage of excessive power consumption of occupancy sensing with image sensor can be overcome.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An occupancy sensing device, comprising:
a region-of-interest (ROI) readout unit, configured to excerpt an ROI image from a plurality of consecutive images of a space in response to an ROI request;
an object tracking unit, coupled to the ROI readout unit, configured to obtain a moving object list according to motion data of the plurality of consecutive images, perform object tracking to determine to send the ROI request according to a first policy and determine an object tracking result according to the moving object list and an object recognition result;
an object recognition unit, coupled to the ROI readout unit, configured to perform object recognition to obtain the object recognition result according to the ROI image; and
an occupancy determination unit, coupled to the object tracking unit, configured to determine an occupancy status of the space according to the object tracking result;
wherein the first policy comprises that the ROI request is sent except that a moving object in the moving object list and a tracking object in a tracking list are corresponding matched; and
wherein the object tracking result comprises the tracking list.

2. The occupancy sensing device of claim 1, further comprising a sensor array, configured to capture the plurality of consecutive images of the space.

3. The occupancy sensing device of claim 2, further comprising a motion detection unit, coupled to the sensor array, configured to performing motion detection to the plurality of consecutive images captured from the sensor array so as to obtain the motion data.

4. The occupancy sensing device of claim 1, wherein the ROI readout unit is comprised in an image sensor of the occupancy sensing device, and the object tracking unit, the object recognition unit and the occupancy determination unit are comprised in a processor of the occupancy sensing device.

5. The occupancy sensing device of claim 1, wherein the ROI readout unit and the object tracking unit are comprised in an image sensor of the occupancy sensing device, and the object recognition unit and the occupancy determination unit are comprised in a processor of the occupancy sensing device.

6. The occupancy sensing device of claim 1, wherein the motion data comprises a motion map or a plurality of bounding boxes corresponding to regions with motion.

7. The occupancy sensing device of claim 1, wherein the ROI request comprises region information corresponding to the appearance and disappearance of the moving object determined according to the moving object list.

8. The occupancy sensing device of claim 1, wherein the object recognition is based on a Convolutional Neural Network (CNN) model.

9. The occupancy sensing device of claim 1, wherein the object recognition result indicates presence or absence of an object of interest.

10. An occupancy sensing method, comprising:
excerpting an ROI image from a plurality of consecutive images of a space in response to an ROI request;
obtaining a moving object list according to motion data of the plurality of consecutive images, performing object tracking to determine to send the ROI request according to a first policy and determine an object tracking result according to the moving object list and an object recognition result;
performing object recognition to obtain the object recognition result according to the ROI image; and
determining an occupancy status of the space according to the object tracking result;
wherein the first policy comprises that the ROI request is sent except that a moving object in the moving object list and a tracking object in a tracking list are corresponding matched; and
wherein the object tracking result comprises the tracking list.

11. The occupancy sensing method of claim 10, wherein the motion data comprises a motion map or a plurality of bounding boxes corresponding to areas with motion.

12. The occupancy sensing method of claim 10, wherein the ROI request comprises region information corresponding to the appearance and disappearance of the moving object determined according to the moving object list.

13. The occupancy sensing method of claim 10, wherein the object recognition is based on a Convolutional Neural Network (CNN) model.

14. The occupancy sensing method of claim 10, wherein the object recognition result indicates presence or absence of an object of interest.
